(19) United States
(12) Patent Application Publication
(10) Pub. No.: US 2020/0167702 A1
(43) Pub. Date: May 28, 2020

(54) METHOD AND APPARATUS FOR MANAGING A VEHICLE RESERVATION USED IN AN INTERMODAL ROUTE

(71) Applicant: HERE GLOBAL B.V., Eindhoven (NL)

(72) Inventors: Jerome BEAUREPAIRE, Berlin (DE); Jens UNGER, Berlin (DE)

(21) Appl. No.: 16/203,261

(22) Filed: Nov. 28, 2018

(51) Int. Cl. G06Q 10/02; G06Q 50/30; G01C 21/34; G06Q 30/02

(52) U.S. Cl. CPC G06Q 10/025; G06Q 30/0283; G01C 21/3423; G06Q 50/30

(57) ABSTRACT

An approach is provided for managing a vehicle reservation used in an intermodal route. A routing platform determines that the intermodal route includes a segment to be traveled using a vehicle booked via the vehicle reservation, and another segment that is traveled using a different mode of transport for a user to reach the vehicle to travel the segment. The routing platform monitors an expiration period of the vehicle reservation and a user location of the user on the another segment. The routing platform calculates a probability that the user will reach the vehicle to travel the segment before an end of the expiration period based on the user location. The routing platform generates at least one route option based on the probability, wherein the at least one route option includes an extension the vehicle reservation, and/or a creation of another vehicle reservation for another vehicle.

### BACKGROUND

Service providers and automobile manufacturers are continually challenged to deliver value and convenience to consumers by, for example, providing compelling network services. One area of interest has been the development of location-based services to that involve generating an intermodal or multimodal route that uses a combination of various transport modes (e.g., including a reservation of shared vehicles) to complete a trip. For example, in some scenarios, when at least one leg of an intermodal route is a shared vehicle, there is a risk that the reservation for this vehicle can expire while the user is travelling towards that leg. In some cases, the shared vehicle (e.g., a shared bicycle, car, etc.) that a user may use to complete a route can also be picked at different locations, thereby adding additional complexity. Under this type of scenario, service providers face significant technical challenges to optimizing the allocation of shared vehicles, considering availability of the shared vehicles and reservation related constraints, other alternate shared vehicles of different types and operated by various entities, to minimize route cost factors (e.g., time, distance, etc.).

### SOME EXAMPLE EMBODIMENTS

Therefore, there is a need for an approach for managing a vehicle reservation used in an intermodal route.

According to one embodiment, a method comprises determining that the intermodal route includes a segment to be traveled using a vehicle booked via the vehicle reservation, and another segment that is traveled using a different mode of transport for a user to reach the vehicle to travel the segment. The method also comprises monitoring an expiration period of the vehicle reservation and a user location of the user on the another segment. The method further comprises calculating a probability that the user will reach the vehicle to travel the segment before an end of the expiration period based on the user location. The method further comprises generating at least one route option based on the probability, wherein the at least one route option includes an extension the vehicle reservation, a creation of another vehicle reservation for another vehicle, or a combination thereof.

According to another embodiment, an apparatus comprises at least one processor, and at least one memory including computer program code for one or more computer programs, the at least one memory and the computer program code configured to, with the at least one processor, determine that the intermodal route includes a segment to be traveled using a vehicle booked via the vehicle reservation, and another segment that is traveled using a different mode of transport for a user to reach the vehicle to travel the segment. The apparatus is also caused to monitor an expiration period of the vehicle reservation and a user location of the user on the another segment. The apparatus is further caused to calculate a probability that the user will reach the vehicle to travel the segment before an end of the expiration period based on the user location. The apparatus is further caused to generate at least one route option based on the probability, wherein the at least one route option includes an extension the vehicle reservation, a creation of another vehicle reservation for another vehicle, or a combination thereof.

According to another embodiment, a computer-readable storage medium carries one or more sequences of one or more instructions which, when executed by one or more processors, cause, at least in part, an apparatus to determine that the intermodal route includes a segment to be traveled using a vehicle booked via the vehicle reservation, and another segment that is traveled using a different mode of transport for a user to reach the vehicle to travel the segment. The apparatus is also caused to monitor an expiration period of the vehicle reservation and a user location of the user on the another segment. The apparatus is further caused to calculate a probability that the user will reach the vehicle to travel the segment before an end of the expiration period based on the user location. The apparatus is further caused to generate at least one route option based on the probability, wherein the at least one route option includes an extension the vehicle reservation, a creation of another vehicle reservation for another vehicle, or a combination thereof.

According to another embodiment, an apparatus comprises means for determining that the intermodal route includes a segment to be traveled using a vehicle booked via the vehicle reservation, and another segment that is traveled using a different mode of transport for a user to reach the vehicle to travel the segment. The apparatus also comprises means for monitoring an expiration period of the vehicle reservation and a user location of the user on the another segment. The apparatus further comprises means for calculating a probability that the user will reach the vehicle to travel the segment before an end of the expiration period based on the user location. The apparatus further comprises means for generating at least one route option based on the probability, wherein the at least one route option includes an extension the vehicle reservation, a creation of another vehicle reservation for another vehicle, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system for managing a vehicle reservation used in an intermodal route, according to one embodiment;

FIG. 1B is a diagram of a transportation database, according to one embodiment;

FIG. 2 is a diagram of the components of a routing platform, according to one embodiment;

FIG. 3 is a flowchart of a process for managing a vehicle reservation used in an intermodal route, according to one embodiment;

FIG. 4 is a diagram of a candidate route and respective route options, according to one embodiment;

FIG. 5 is a diagram of vehicle reservation strategies, according to various embodiments;

FIG. 6 is a diagram of a user interface used in the processes for managing a vehicle reservation used in an intermodal route, according to one embodiment;

FIG. 7 is a diagram of a user interface used in the processes for managing a vehicle reservation used in an intermodal route, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., mobile computer) that can be used to implement an embodiment of the invention.

### DESCRIPTION OF SOME EMBODIMENTS

Examples of a method, apparatus, and computer program for managing a vehicle reservation used in an intermodal route are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

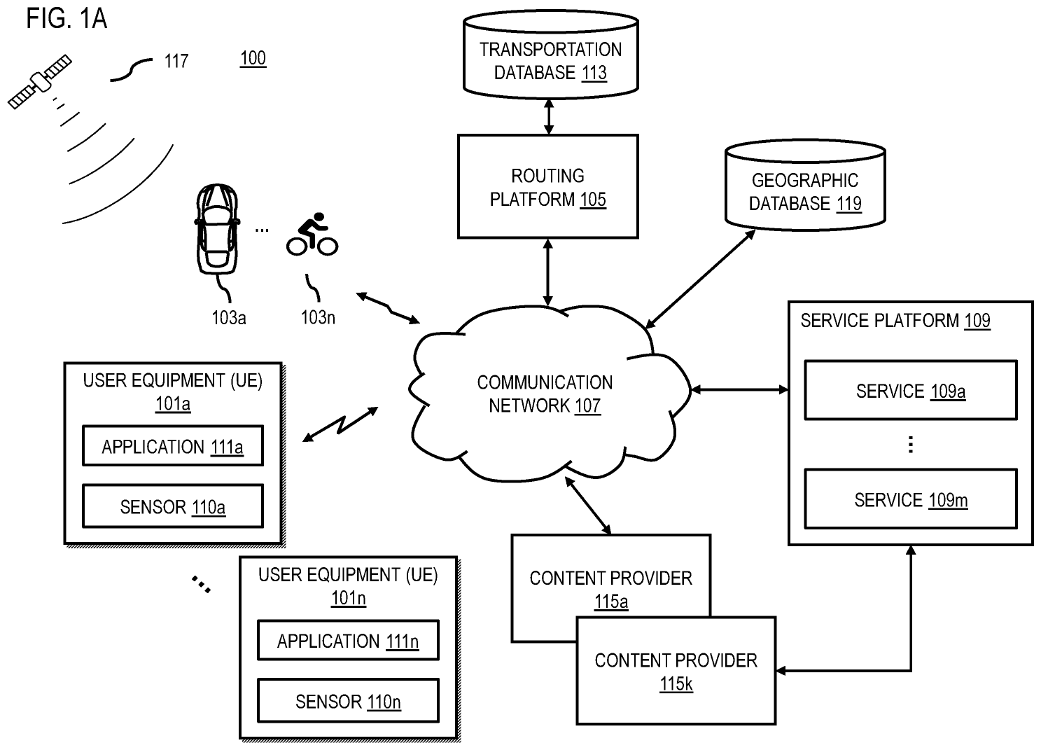

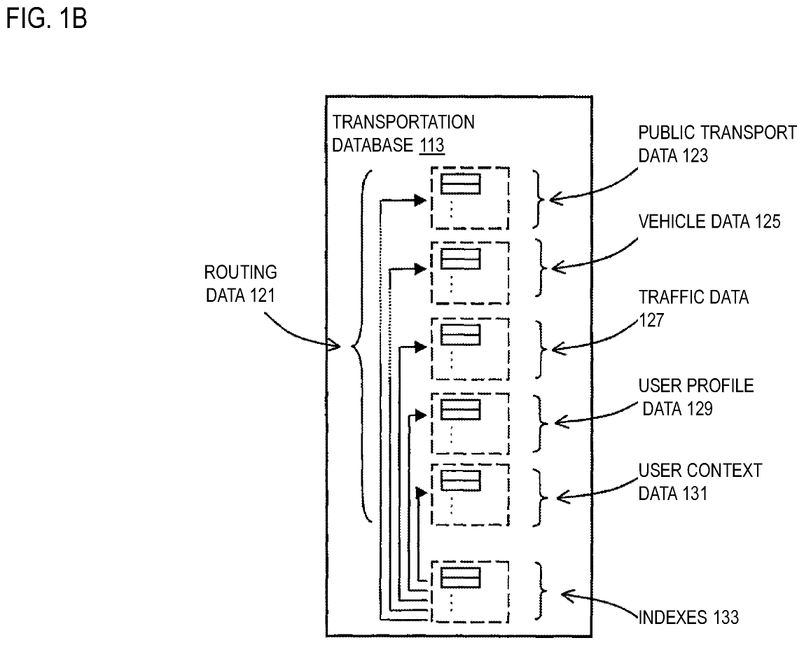

FIG. 1A is a diagram of a system for managing a vehicle reservation used in an intermodal route, according to one embodiment. As transportation options or modes of transport (e.g., personal vehicles, shared vehicles, autonomous vehicles, public transport, etc.) increase, the task of generating a route to guide a user to a destination is also increasing in complexity. For example, traditional routes initially guided uses using only one means of transport (e.g., car, bus, walking, etc.). Then systems and service became available to guide users over multiple means of transport using intermodal or multimodal routes. As used herein, an intermodal/multimodal route is a route that uses different means of transport on different legs or segments of the route to complete a trip from origin to destination. For example, a user may be guided to drive a car from an origin to waypoint (e.g., via driving instructions) and then complete the journey by walking the from the waypoint to the final destination (e.g., using walking instructions). In another example, many long intermodal routes end-up on the last mile with a bus segment for a few stations only, this means that the user may need to wait for a (low-frequency) bus to just be inside the bus for a few minutes before still finishing on foot.

With the emergence of shared vehicle services (e.g., shared cars, bicycles, scooters, etc.), the options for generating intermodal routes have also increased. By way of example, shared vehicle services generally offer a fleet of vehicles that can be “booked” or reserved for use by end users. Hence, intermodal solutions that add a shared vehicle segment to an intermodal route can a provide valuable service to consumers by providing additional options to enable a user to complete a trip more efficiently while frustrations associated with other forms of transport (e.g., by skipping the waiting time for a bus or train and allowing a non-interrupted and less frustrating journey).

However, because some shared vehicle services generally rely on users to reserve or book their shared vehicles in advance (e.g., to ensure availability and provide for more efficient fleet management), booking related constraints (e.g., booking periods, reservation expiration times, pick-up locations, number of available vehicles, etc.) can affect whether an intermodal route can be completed as generated. For example, delays on a prior leg of an intermodal route (e.g., caused by congestion, traffic incidents, etc.) before reaching the leg to be completed using a booked or reserved vehicle can affect whether the booked or reserved vehicle would be available when the user reaches the vehicle. Therefore, there is a need to properly manage the booking or reservation of a shared vehicle used as part of an intermodal route without abusing the existing booking system and causing the shared vehicle service to potentially lose money (e.g., if unnecessarily long hold periods for shared vehicles are provided to account for delays in intermodal routes which could reduce the number of customers served or the utilization rates of the shared vehicles).

However, providing of dynamic intermodal routes or changing a reservation of a vehicle located in vicinity of a user location or en route to a user destination before the vehicle reservation expires can be technically challenging. In particular, managing the reservation when a user is running late to pick up the vehicle can be a challenging task. For example, manually extending the reservation or re-booking another vehicle can be time consuming and frustrating, particularly when the user is on the go and running late, when the user is travelling to a restricted area (e.g., vehicle type limitations, license plate limitations, etc.), or when the traffic around the user destination is blocked or too congested for certain types of vehicles to get to, or when the user destination has limited cellular and/or internet reception. Historically, conventional vehicle reservation systems may offer assistance by routing the user to a vehicle without considering various types of vehicles (e.g., a car, a motorcycle, an electric bike, an electric scooter, a bicycle, a boat, etc.) managed by different operators, relevant reservation criteria (e.g., a reservation time length, a number of concurrent reservation limit, etc.), promotions (e.g., the first 30 minutes free for a new user, a bonus if returning to the pickup location or preferred locations, etc.), dropping off criteria (e.g., distance, location, area limitations), the route to the final destination of the user, etc. As a result, conventional routes may take more money, time and/or distance than necessary to complete, thereby potentially wasting vehicle resources and providing for a poorer user experience.

To address this problem, a system 100 of FIG. 1A introduces a capability to efficiently create the next general of intermodal routing services by providing for dynamic booking or reservation of vehicles used in intermodal routes. In one embodiment, the system 100 can dynamically change a vehicle reservation before it expires and the routing the user to the vehicle or another vehicle for traveling to a user destination (as opposed, e.g., to manually changing the vehicle reservation in traditional methods) based on monitoring the user's progress in prior segments or legs of the intermodal route. The system 100 can then use the monitored progress to determine or predict whether the user will be able to reach the route segment that is to be completed with the reserved vehicle given any booking constraints (e.g., reservation expiration times, vehicle availability, etc.).

In one embodiment, the system 100 optimizes a user's travel time (or route or other routing cost function parameter such as distance, fuel efficiency, etc.) to a destination by considering all possible modes of transport (e.g., public transport buses, trains, cars, pedestrian modes, etc.) along with a shared vehicle. In one embodiment, the system 100 can use a routing cost function, dynamic (or real time) traffic monitoring and timing adjustments to identify an optimal reservation change (e.g., if determined to be needed) to reach a shared vehicle segment of an intermodal route and ultimately to the final destination, before an existing vehicle reservation expires or other booking constraint applies (e.g., fee increase, vehicle availability change, pick-up location hours, etc.). Optimal, for instance, refers to a vehicle reservation change that enables the user to pick up a vehicle to reach a final destination with a time, distance, etc. that meets threshold requirements or is a minimum among calculated candidate routes, vehicles, and/or locations. As indicated, the route can be an intermodal/multimodal route that combines the use of multiple different modes of transport. For example, an intermodal/multimodal route can direct a user to walk to a vehicle pick up location, then take a shared vehicle to a user destination. In this example, the multimodal route comprises a first walking segment, and a second shared vehicle segment.

In one embodiment, the system 100 can determine alternate transport availability information (e.g., either the availability of alternate transport modes or the unavailability of alternate transport modes) based on static transport schedule data, and/or real-time transport tracking data, using intermodal and multimodal routing algorithms. By way of example, the alternate transport modes may include a public transit mode, a pedestrian mode, a bicycling mode, a shared vehicle, etc. The public transit mode may include micro-transit solutions that work on an on-demand basis. For example, as a part of the first leg of a journey to the user destination, delays are caused by detours made by such a micro-transit vehicle (e.g., a minibus) when new users register en-route such that make some passengers miss the end of their reservations time. The system 100 can determine the delays and make dynamic re-bookings for those passengers. A shared vehicle may be a car, a motorcycle, an electric bike, an electric scooter, a bicycle, a kickboard, a mini scooter, a boat, etc. owned by an individual, a commercial business, a public agency, a cooperative, or an ad hoc grouping.

As previously described, the vehicle may be a vehicle reserved by the user; however, the user is likely to reach a pickup location after the reservation period. The vehicle (e.g., cars, motorcycles, electric bikes, electric scooters, bicycles, boats, airplanes, etc.) can be human-operated, semi-autonomous, or autonomous. Although various embodiments are described with respect to a transfer from a no-reservation-required transport mode to a reservation-required transport mode, it is contemplated that the approach described herein may be used with other types of transfers, such as a transfer from a reservation-required transport mode to another reservation-required transport mode, and the system 100 can handle any numbers of such transfers towards the user destination. In one embodiment, the user reserved an autonomous vehicle which operates autonomously to a location for the user to pick up and then travel to the final destination of the user. In another embodiment, the user reserved a human-operated or semi-autonomous vehicle and finds another driver (e.g., a contact or a stranger) to operate the vehicle to a meeting point, to either handover the vehicle to the user or to continue riding together with the user to a destination. In another embodiment, the human-operated or semi-autonomous vehicle is owned by a business entity, a public entity, a stranger, or a contact of the user, and the contact or stranger agrees to operate the vehicle to a meeting point, to either handover the vehicle to the user or to continue riding together with the user to a destination. These embodiments are applicable to centralized ride-sharing, peer-to-peer ride-sharing, car-pooling, taxi cabs, food delivery, etc.

In one embodiment, the system 100 includes one or more processes for automatically determining if and where a user may need a route that includes dynamic handover points for meeting a shared vehicle to travel to a destination, and an online service collecting routing information and providing guidance to the user to reach the destination faster and/or cheaper using the candidate pickup locations and/or vehicle reservation changes made according to the embodiments described herein. In one embodiment, the system 100 receives a user request to explicitly reserve the vehicle to travel to a destination. Alternatively, the user can request a route to a final destination such that one possible candidate vehicle and/or the best calculated route (e.g., route taking the least amount of travel cost, time, and/or distance) includes one or more candidate pickup locations. In another embodiment, the system 100 detects a user travel pattern/habit and predicts the user's need for reserving a vehicle to reach a destination. In yet another embodiment, the system 100 detects the user's need for reserving a vehicle from an entry in the user's calendar, a social media event accepted or signed up by the user, an event in the user's message (e.g., email, text message, instant message, SMS message, MMS message, etc.).

In one embodiment, UEs 101 of a user and sensors in a vehicle 103 are collecting and reporting data (e.g., location data) to the system 100 to support the determining candidate pickup locations and/or vehicle reservation changes according to the embodiments described herein. In this way, for instance, vehicles 103a-103n and/or vehicle users can use the system for sharing trajectory data and receiving vehicle supply and demand information as well as contextual data (e.g., traffic, weather conditions, etc.) that can be used to dynamically update the candidate pickup locations and/or vehicle reservation changes to determine the route option (including one or more vehicle reservation changes) that optimizes or reduces the amount of cost, time, distance, etc. to a destination. With this data along with other data such as but not limited to public transport information, the system 100 (e.g., a routing platform 105) can compute candidate route options to a destination that includes one or more segments for the user to travel via one or more transport modes to pick up the vehicle and a segment for the user/vehicle to travel to the final destination. In this way, the system 100 can more precisely present to the user transport modes to travel to the pickup point then get to the destination in the vehicle. In one embodiment, the UEs 101 and the routing platform 105 have connectivity via a communication network 107.

In one embodiment, the vehicles 103a-103n are equipped with a device (e.g., the UE 101 or other accessory device) that records the vehicles' trajectory data (e.g., position, speed, etc.). In one embodiment, the UE 101 may be configured with one or more sensors 110a-110n (also collectively referred to as sensors 110) for determining the trajectory data (including parking locations). By way of example, the sensors 110 may include location sensors (e.g., GPS), accelerometers, compass sensors, gyroscopes, altimeters, etc.

In one embodiment, after a journey or the trajectory data is recorded (e.g., upon parking), the trajectory data is analyzed (e.g., by respective applications 111a-111n and/or the routing platform 105 for storage in, for instance, a transportation database 113 and/or a geographic database 119) to detect parking locations where the vehicle remains reserved by the user or becomes available for new reservations. Applications 111a-111n preform navigation and/or routing functions independently or in conjunction with the routing platform 105. In one embodiment, the routing platform 105 and/or applications 111 receive a user request to explicitly release the vehicle. Alternatively, the user can request a different vehicle from a current location to another destination such that the routing platform 105 assumes that the user releases the vehicle for new reservations.

In another embodiment, the user requests to pick up a different vehicle from a location different from the current location while sensor data reveals that the user is walking from the current location towards the different location. In this case, the system 100 assumes that the user releases the vehicle for new reservations.

In another embodiment, the system 100 detects a user travel pattern/habit using machine learning algorithms and predicts that the user releases the vehicle for new reservations. In yet another embodiment, the system 100 detects that the user releases the vehicle for new reservations based on an entry in the user's calendar (e.g., jogging), a social media event accepted or signed up by the user (e.g., a marathon race), an event in the user's message (e.g., email, text message, instant message, SMS message, MMS message, etc.).

In one embodiment, timestamp information indicates at which time and which location the vehicle was parked is recorded as a record in the transportation database 113. In one embodiment, the record is then transmitted or uploaded to the routing platform 105. In addition or alternatively, the raw trajectory data may be uploaded to the routing platform 105 to determine the record. In yet another embodiment, the record and/or trajectory data may be maintained at the UE 101 device for local processing to determine vehicle parking information for transmission to the routing platform 105 and/or other vehicles/UEs 101 (e.g., when operating in a peer-to-peer network architecture).

In one embodiment, when the UE 101 requests optimal routes to pick up the vehicle 103 at or near a vehicle parking location then riding to a destination, the routing platform 105 computes candidate routes that includes a segment for the user to travel from the user location to a vehicle parking location via an alternate transport mode and a segment for the vehicle to travel from the vehicle location to the user destination, based on data from the transportation database 113 and/or the geographic database 119. The alternate transport mode may include walking, cycling, motorbiking, taking one or more taxis, taking one or more buses, taking one or more trains, taking one or more subways, taking one or more ferries, taking one or more shared vehicles, or a combination thereof.

In one embodiment, the routing platform 105 computes a segment for the user to get to the vehicle pickup location using the alternate transport mode, assuming there is no delay of the estimated arrival time. In another embodiment, the routing platform 105 computes a segment for the user to get to the vehicle pickup location using the alternate transport mode and a potential delay to arrive the vehicle parking location after the vehicle reservation period, when detecting there is traffic and/or weather delay of the estimated arrival time to pass the vehicle reservation period. In this case, the routing platform 105 generates at least one route option based on the potential delay to arrive the vehicle parking location. The at least one route option includes an extension the vehicle reservation, a creation of another vehicle reservation for the same vehicle or another vehicle of the same type at or near the pickup location, a creation of another vehicle reservation for a different vehicle type with a similar estimated arrival time at or near the pickup location, a creation of another vehicle reservation for another vehicle at a different pickup location, etc.

In one embodiment, the routing platform 105 is configured to monitor the user and/or the alternate transport in order to generate travel status information. In addition, the routing platform 105 may present to the user a real-time status of the user, and/or an estimated or predicted status of the user to arrive at a vehicle parking location. The status information may also be associated with timestamp information and/or other contextual information (including parking) to store in the transportation database 113. In one embodiment in which timestamp information is available, for each travel or street segment of interest, the routing platform 105 retains the latest time at which the alternate transport departed and estimate when the user will arrive at the vehicle parking location.

In one embodiment, the routing platform 105 computes a cost function for extending the vehicle reservation, and a cost function for creating another vehicle reservation for another vehicle, based on data from the transportation database 113 and/or the geographic database 119. The routing platform 105 compares costs of the two route options, and then presents the costs and/or recommend the cheaper route option.

In another embodiment, the routing platform 105 may present to the user information on points of interest, parking areas, road segments, and/or related information retrieved from the geographic database 119, while the user is traveling on the transport mode segment and/or in the vehicle. In addition or alternatively, such information can be provided by the service platform 109, one or more services 109a-109m (also collectively referred to as services 109), one or more content providers 115a-115k (also collectively referred to as content providers 115), or a combination thereof. For example, the sources of the information may include map data, information inferred from data collected from participating vehicles, or a combination thereof.

In one embodiment, apart from an optimal or recommended candidate route option, the routing platform 105 may also update the information as a map overlay that illustrates, for instance, timestamps, a number of alternate transport modes available, and fluctuations in the amount of alternate transport modes, etc. around the user location or position (e.g., a current location of the client UE 101), based on real-time transport data from the transportation database 113.

In one embodiment, vehicles 103 are equipped with a navigation device (e.g., a UE 101) that is capable of submitting to the routing platform 105 requests for routing the user and the vehicle to a pickup location and of guiding of the user and the vehicle respectively. In one embodiment, as the user and the vehicle follow the respective segments, the UE 101 (e.g., via an application 111) and the vehicle 103 may iterate their locations with timestamps to the routing platform 105 in order to update the travel status in a real-time and/or substantially real-time manner while factoring in delay caused by traffic, weather, etc.

In one embodiment, a reservation change request can be triggered by interactions with a user interface of the UE 101 (e.g., an explicit request from a user with a vehicle reservation), or automatically when inferring the user's need to change vehicle reservation from user profile information and/or user context information. In yet another embodiment, the UE 101 can initiate a reservation change request when the UE 101 detects that the user mentions a changing vehicle reservation need in an email, calendar entry, web post, etc. In this way, vehicle reservation change can be made even when no explicit reservation change request is set or known by the system 100.

As shown in FIG. 1A, the routing platform 105 operates in connection with UEs 101 and vehicles 103 for managing a vehicle reservation used in an intermodal route. By way of example, the UEs 101 may be any mobile computer including, but not limited to, an in-vehicle navigation system, vehicle telemetry device or sensor, a personal navigation device (“PND”), a portable navigation device, a cellular telephone, a mobile phone, a personal digital assistant (“PDA”), a wearable device, a camera, a computer and/or other device that can perform navigation or location based functions, i.e., digital routing and map display. In some embodiments, it is contemplated that mobile computer can refer to a combination of devices such as a cellular telephone that is interfaced with an on-board navigation system of an autonomous vehicle or physically connected to the vehicle for serving as the navigation system. Also, the UEs 101 may be configured to access a communication network 107 by way of any known or still developing communication protocols. Via this communication network 107, the UE 101 may transmit probe data as well as access various network based services for facilitating managing a vehicle reservation used in an intermodal route.

Also, the UEs 101 may be configured with applications 111 for interacting with one or more content providers 115, services of the service platform 109, or a combination thereof. Per these services, the applications 111 of the UE 101 may acquire routing instructions, transport mode information, traffic information, mapping information and other data associated with the current locations of the user and the vehicle, etc. Hence, the content providers 115 and service platform 109 rely upon the gathering of user, vehicle, and transport modes trajectory data and routing data for executing the aforementioned services.

The UEs 101 and the vehicles 103 may be configured with various sensors 110 for acquiring and/or generating trajectory data regarding the user, a vehicle, other vehicles, conditions regarding the driving environment or roadway, etc. For example, sensors 110 may be used as GPS receivers for interacting with one or more satellites 117 to determine and track the current speed, position and location of a user and/or a vehicle travelling along a roadway. In addition, the sensors 110 may gather tilt data (e.g., a degree of incline or decline of the vehicle during travel), motion data, light data, sound data, image data, weather data, temporal data and other data associated with UEs 101 and/or the vehicle 103 thereof. Still further, the sensors 110 may detect local or transient network and/or wireless signals, such as those transmitted by nearby devices during navigation of a vehicle along a roadway. This may include, for example, network routers configured within a premise (e.g., home or business), another UE 101 or vehicle 103 or a communicable traffic system (e.g., traffic lights, traffic cameras, traffic signals, digital signage). In one embodiment, the routing platform 105 aggregates probe data gathered and/or generated by the UEs 101 and/or the vehicle 103 resulting from the driving of multiple different vehicles over a road/travel network. The probe data may be aggregated by the routing platform 105 to manage a vehicle reservation used in an intermodal route.

By way of example, the routing platform 105 may be implemented as a cloud based service, hosted solution or the like for performing the above described functions. Alternatively, the routing platform 105 may be directly integrated for processing data generated and/or provided by service platform 109, content providers 115, and/or applications 111. Per this integration, the routing platform 105 may perform candidate routes calculation based on user/vehicle trajectory information and/or public transport information.

By way of example, the communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the UEs 101, the vehicles 103, the routing platform 105, the service platform 109, and the content providers 115 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 1B is a diagram of the transportation database 113, according to one embodiment. In one embodiment, vehicle information and/or any other information used or generated by the system 100 with respect to manage a vehicle reservation used in an intermodal route based on routing data 121 stored in the transportation database 113 and associated with and/or linked to the geographic database 119 or data thereof.

In one embodiment, the routing data 121 include public transport data 123, vehicle data 125, traffic data 127, user profile data 129, user context data 131, indexes 133, etc. In one embodiment, the public transport data 123 can include any public transport data item used by the routing platform 105 including, but not limited to public transport type data, public transport schedule data, public transport route and stop data, real-time public transport trajectory data, etc. retrieved from transit agencies, public transportation operators, etc. In one embodiment, the public transport data can be used in junction with the user profile data 129 and the user context data 131 for estimating an estimated arrival time for the user to arrive at a vehicle pickup location and generating route options of an extension the vehicle reservation and/or a creation of another vehicle reservation for another vehicle. In another embodiment, the traffic data 127 is further included for estimating the estimated arrival time for the user to arrive at a vehicle pickup location and generating route options of an extension the vehicle reservation and/or a creation of another vehicle reservation for another vehicle. The public transport data format may be in General Transit Feed Specification (GTFS), REST/XML, or other industry standards for publishing transportation network and schedule data. In one embodiment, the public transport can include but is not limited to on-demand services (e.g., taxis, shared vehicles, etc.) and fixed-route services such as city buses, trolleybuses, trams (or light rail) and passenger trains, rapid transit (metro/subway/underground, etc.), ferries, airlines, coaches, intercity rail, etc.

In one embodiment, the vehicle data 125 can include any vehicle data item used by the routing platform 105 including, but not limited to vehicle type data, vehicle ownership data, vehicle route and step data, real-time vehicle trajectory data, parking instance data, timestamp information for the parking instance data, etc. for estimating the estimated arrival time for the user to arrive at a vehicle pickup location, and generating route options of an extension the vehicle reservation and/or a creation of another vehicle reservation for another vehicle. In another embodiment, the traffic data 127 is further included for estimating the estimated arrival time for the vehicle to arrive at the user destination.

In one embodiment, the traffic data 127 includes, but not limited to, travel speeds, congestions, detours, vehicle types and volumes, accidents, road conditions, road works, etc. on specific road segments.

In one embodiment, the user profile data 129 includes, but not limited to, the name, name, login named, screen named, nicknamed, handle names, home addresses, email addresses, government identification numbers, operator license/credential types (motorcycle, regular passenger vehicle, commercial vehicle, etc.), vehicle registration plate numbers, face, fingerprints, handwriting, credit card numbers, digital identities, date of birth, age, birthplace, genetic information (e.g., gender, race, etc.), telephone numbers, marriage status/records, criminal records, purchase records, financial data, activity records, employment records, insurance records, medical records, political and non-political affiliations, preferences (e.g., POIs), calendar data, driving history data, vehicle sharing data, etc. of the user.

In one embodiment, the user context data 131 includes, but not limited to, a destination of the user, a type of the destination of the user, a proximity of the user location to a vehicle pickup location or the destination, availability of an alternate destination for the user, a number of passengers accompanying the user, weather data in the vicinity of the user, etc.

More, fewer or different data records can be provided in the transportation database 113. One or more portions, components, areas, layers, features, text, and/or symbols of the routing data records in the transportation database 113 can be stored in, linked to, and/or associated with one or more of the data records of the geographic database 119 (such as mapping and/or navigation data).

In one embodiment, the geographic database 119 includes geographic data used for (or configured to be compiled to be used for mapping and/or navigation-related services, such as for route information, service information, estimated time of arrival information, location sharing information, speed sharing information, and/or geospatial information sharing, according to exemplary embodiments. For example, the geographic database 119 includes node data records, road segment or link data records, POI data records, parking availability data records, and other data records.

In exemplary embodiments, the road segment data records are links or segments representing roads, streets, or paths, as can be used in the calculated route or recorded route information. The node data records are end points corresponding to the respective links or segments of the road segment data records. The road link data records and the node data records represent a road network, such as used by vehicles, cars, and/or other entities. Alternatively, the geographic database 119 can contain path segment and node data records or other data that represent pedestrian paths or areas in addition to or instead of the vehicle road record data, for example.

The road link and nodes can be associated with attributes, such as geographic coordinates, street names, address ranges, speed limits, turn restrictions at intersections, and other navigation related attributes, as well as POIs, such as traffic controls (e.g., stoplights, stop signs, crossings, etc.), gasoline stations, hotels, restaurants, museums, stadiums, offices, automobile dealerships, auto repair shops, buildings, stores, parks, etc. The geographic database 119 can include data about the POIs and their respective locations in the POI data records. The geographic database 119 can also include data about places, such as cities, towns, or other communities, and other geographic features, such as bodies of water, mountain ranges, etc.

The transportation database 113 and/or the geographic database 119 can be maintained by the content provider in association with the service platform 109 (e.g., a map developer). The map developer can collect driving/parking data and geographic data to generate and enhance the transportation database 113 and/or the geographic database 119. There can be different ways used by the map developer to collect data. These ways can include obtaining data from other sources, such as municipalities or respective geographic authorities.

The transportation database 113 and/or the geographic database 119 can be stored in a format that facilitates updating, maintenance, and development of the relevant data. For example, the data in the transportation database 113 and/or the geographic database 119 can be stored in an Oracle spatial format or other spatial format. The Oracle spatial format can be compiled into a delivery format, such as a geographic data files (GDF) format to be compiled or further compiled to form geographic database products or databases, which can be used in end user navigation devices or systems.

As mentioned above, the transportation database 113 and the geographic database 119 are separated databases, but in alternate embodiments, the transportation database 113 and the geographic database 119 are combined into one database that can be used in or with end user devices (e.g., UEs 101) to provide navigation-related functions and provide shared vehicle information. For example, the databases 113, 119 are assessible to the UE 101 directly or via the routing platform 105. In another embodiments, the databases 113, 119 can be downloaded or stored on UE 101, such as in applications 111.

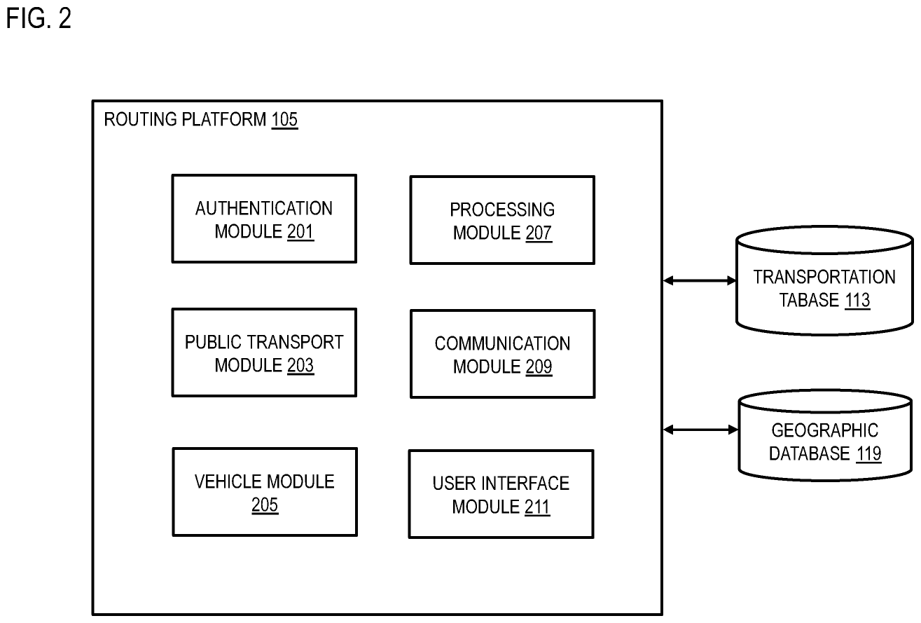

FIG. 2 is a diagram of the components of a routing platform, according to one embodiment. By way of example, the routing platform 105 includes one or more components for managing a vehicle reservation used in an intermodal route. It is contemplated that the functions of these components may be combined or performed by other components of equivalent functionality. In this embodiment, the routing platform 105 includes an authentication module 201, a public transport module 203, a vehicle module 205, a processing module 207, a communication module 209, and a user interface module 211.

In one embodiment, the authentication module 201 authenticates UEs 101 and/or associated vehicles 103 for interaction with the routing platform 105. By way of example, the authentication module 201 receives a request to access the routing platform 105 via an application 111. The request may be submitted to the authentication module 201 via the communication module 209, which enables an interface between the application 111 and the platform 105. In addition, the authentication module 201 may provide and/or validate access by the UE 101 to upload trajectory data, and/or other location-based information to the platform 105. In one embodiment, the authentication module 201 may further be configured to support and/or validate the formation of profile by a provider of a service 109 or content provider 115, e.g., for supporting integration of the capabilities for managing a vehicle reservation used in an intermodal route with said providers 115 or services 109.

The public transport module 203 retrieves the public transport data 123 (including fixed-route and/or on-demand public transports and associated schedules and timestamps) from various sources such as the transportation database 113, transit agencies, public transportation operators, etc. In one embodiment, the public transport module 203 aggregates schedules of various public transport that are operated on fixed schedules. In another embodiment, the public transport module 203 analyzes trajectory data (including associated timestamps) uploaded by one or more authenticated public transport passenger UE 101 and/or various public transport (e.g., demand-responsive transit, such as flexible routing and/or flexible scheduling minibuses) to determine the status of the transports that operate on demand. In one embodiment, the public transport module 203 may receive other related data along with the trajectory data or segment lists such as acceleration, road curvature, vehicle tilt, driving mode, brake pressure, etc. It then stores the received data to database 113 optionally in association with a unique identifier of the various public transport that transmitted the trajectory data.

The vehicle module 205 collects and/or analyzes trajectory data (including associated timestamps) as generated by one or more authenticated UE 101 and one or more vehicles 103. For example, the vehicle module 205 aggregates the trajectory data of travel segments generated by the UE 101 and the one or more vehicles 103. In one embodiment, the vehicle module 205 may receive other related data along with the trajectory data or segment lists such as acceleration, road curvature, vehicle tilt, driving mode, brake pressure, etc. It then stores the received data to database 113 optionally in association with a unique identifier of the vehicle, driver of UE 101 that transmitted the trajectory data or lists.

In one embodiment, the processing module 207 manages a vehicle reservation used in an intermodal route that includes a segment to be traveled using a vehicle booked via the vehicle reservation, and another segment that is traveled using a different mode of transport for a user to reach the vehicle. For example, the processing module 207 monitors an expiration period of the vehicle reservation and a user location of the user on the another segment based on real-time trajectory data. In another embodiment, the processing module 207 estimates the user location on the another segment based on the last known location and estimates the user movement based on predicted movement of the different mode of transport, such as walking, cycling, buses, etc., in absence of real-time trajectory data, such as the user is traveling in a poor GPS coverage area.

In one embodiment, the processing module 207 calculates a probability that the user will reach the vehicle to travel the segment before an end of the expiration period based on the user location. For example, the processing module 207 calculates a probability D which a joint probability distribution or matrix for parameters X, Y, Z . . . that gives the probability that each of X, Y, Z . . . falls in any particular range or discrete set of values specified for that variable. For example, X is a user's profile parameter (e.g., three of four times that the user rode on a bus to the vehicle pickup location and one out of four times that the user walked to the user pickup location), and Y is a is a transport timing parameter (e.g., on time vs. delay). To simplify the discussion, only X and Y are used to generate a joint probability distribution or matrix as Table 1 as follows:

TABLE 1

| | X = bus | X = walk | P(Y) |
|---|---|---|---|
| Y = on time | (1)(3/4) = 3/4 | (1)(1/4) = 0 | 3/4 + 0 = 3/4 |
| Y = delay | (0)(3/4) = 1/4 | (0)(1/4) = 0 | 1/4 + 0 = 1/4 |
| P(X) | 3/4 + 1/4 = 1 | 0 + 0 = 0 | |

In one embodiment, when the probability that the user will reach the vehicle to travel the segment before an end of the expiration period meets or exceeds a threshold value (e.g., 75%), the processing module 207 continues monitoring the expiration period of the vehicle reservation and the user location as well as calculating the probability that the user will reach the vehicle before the end of the expiration period, until the user reaches the vehicle pickup location.

In another embodiment, when the probability that the user will reach the vehicle to travel the segment before an end of the expiration period gets below the threshold value, the processing module 207 generates at least one route option, such as an extension the vehicle reservation, a creation of another vehicle reservation for another vehicle, etc., to minimize the cost function to travel to the user destination.

For example, the system 100 asks the user whether to extend the existing reservation and/or make a new reservation for a different vehicle. If the user chooses “extend the reservation”, the reserved vehicle would remain reserved for the user. If the user chooses “make a new reservation”, the reserved vehicle would be advertised as available for another user. If the user chooses “extend the reservation” and “make a new reservation”, the reserved vehicle would remain reserved for the user, while another vehicle is also reserved for the user as a backup.

As the described idea is about determining a probability that the user will reach the vehicle before the end of the expiration period, the processing module 207 would monitor other factors that influence this probability. For example, if the user was always on time when walking to the pickup location, it is most likely that the user will be on time this time. As another example, as this bus line historically delayed 75% of time during 17:00-18:00, it is likely that the bus will be delay this time period of the day. The system 100 can monitor the user's profile and historic and current transportation data and computes the probability accordingly. If no or fewer data is available, then the uncertainty increases.

Probability is the measure of how likely an event is to occur out of the number of possible outcomes. There exist infinitely many outcomes among many drivers in the vicinity of the requesting user. To simplify the discussion, the probability D in this case, can be identified with a triple (x,y,z) that specifies the probabilities that the user will reach the vehicle before the end of the expiration period. x+y+z=1 and x,y,z are positive. In one embodiment, the other outcomes are not of interest for computing the probability D that the vehicle will become available for the user. In another embodiment, the other outcomes have no statistical significance for computing the probability D that the vehicle will become available for the user.

There also exist infinitely many triples (x,y,z) that satisfy the conditions above (for examples are x=z=⅖, y=⅕ and x=⅓, y=⅙, z=½). Each probability P of an outcome is a combined probability of a series of concurrent and/or sequential events that lead to the outcome P(x and y and z)=P(x)×P(y)×P(z). For example, the outcome of reaching the pickup location p requires: the reserved vehicle is available at the reserved time frame (x), the vehicle pickup location is near a stop of the alternate transport mode (y), and the destination can be reached via the reserved vehicle within a time threshold (z). By analogy, each probability of an event x, y, or z is a combined probability of a series of concurrent and/or sequential sub-events that lead to the event x, y, or z.

In one embodiment, the processing module 207 includes more parameters including additional user's context parameters such as user calendar, user activity, etc., and/or additional user's profile parameters such as vehicle reservation history, etc., to calculate the probability D that the user will reach the vehicle before the end of the expiration period, until the user reaches the vehicle pickup location. When the probability D meets or exceeds a threshold value (e.g., 75%), the processing module 207 continues monitoring the expiration period of the vehicle reservation and the user location as well as calculating the probability that the user will reach the vehicle before the end of the expiration period and prepares data for presenting the share vehicle at the location on a user interface to the user.

The above-discussed embodiments refer to vehicle pickups for car-sharing as examples. These embodiments are applicable to centralized ride-sharing, peer-to-peer ride-sharing, car-pooling, taxi cabs, food delivery, etc.

In one embodiment, the processing module 207 generates at least one route option based on the probability. The at least one route option includes an extension the vehicle reservation, and/or a creation of another vehicle reservation for another vehicle.

In one embodiment, the processing module 207 computes a cost function score for each of the share vehicle candidates via comparing a plurality of features of respective candidates to the plurality of features of the reserved vehicle to determine a number of common features (n) shared between the plurality of features of the respective candidates and the plurality of features of the reserved vehicle, and calculating the cost function score using an equation including a weighting vector (w), the reserved vehicle feature vector (r), a respective candidate feature vector (p):

$$cos t ( r , p ) = {\sum }_{i = 1 -> n} {w}_{i} {r}_{i} {p}_{i}$$

where i=1 to the number of common features shared between the reserved vehicle vector and the candidate feature vectors.

In one embodiment, the vehicle features include a vehicle type (e.g., cars, motorcycles, electric bikes, electric scooters, bicycles, boats, airplanes, etc.), a vehicle model, relevant reservation criteria (e.g., a reservation fee, a reservation time length, a number of concurrent reservation limit, etc.), usage cost (e.g., rental fee per minute, per 30 minutes, per hour, per day, per week, per month, etc.), promotions (e.g., the first 30 minutes free for a new user, a bonus if returning to the pickup location or preferred locations, premium customers can re-book more times than standard users or for a longer period, etc.), dropping off criteria (e.g., distance, location, area limitations), the vehicle pickup location with respect to a stop of the alternate transport mode, the route to the final destination of the user, alternative vehicle pickup locations, user preferences, consumer ratings of the vehicle and/or operator, predictive and/or live traffic near the user destination, scheduling of the alternate transport mode, etc.

By way of example, a tourist may reserve a shared bicycle near the Smithsonian Metro train stop while taking subway from the airport into downtown Washington D.C. However, the Metro train is delayed for mechanical failures at one stop before the Smithsonian Metro train stop. The processing module 207 monitors the predicted and/or real-time traffic between the airport and the user destination, as well as the vehicle fees and availability (including all docked and dockless bicycles of different carriers, etc.) near all Metro stops en route to the user destination. The processing module 207 generates a list of one or more share vehicle candidates based on the cost function scores. In one embedment, the processing module 207 automatically executes the optimal route option form the list for the user. In another embodiment, the processing module 207 presents the list on a user interface and prompts for a user selection. For example, the processing module 207 prompts the user to reserve a different bicycle and get off the Metro train two stops earlier to avoid the bottleneck.

In one embodiment, once the route options are determined, the processing module 207 can interact with the communication module 209 and/or the user interface module 211 to present to the user the route options. After the user selects a route option, the processing module 207 can interact with the communication module 209 and/or the user interface module 211 to present to the user updated reservation and timing information, related navigation instructions, and/or other information related to the vehicle timing and vehicle navigation information.

The processing module 207 provides the user vehicle data of the route option (e.g., vehicle type, model, fees, operation limits, etc.), and optionally timing information. In one embodiment, the processing module 207 provides to the user navigation instructions, and/or other information to the user to locate the vehicle.

Since there can be delays caused by predictive and/or live traffic, weather, etc. for the user, the processing module 207 updates the user location, the alternate transport location, or a combination thereof based on data from the transportation database 113 that is obtained via real-time monitoring by the system 100. In one embodiment, the processing module 207 updates the probability calculation and the cost function scores based on the updated user location and/or alternate transport location and updates the list of share vehicle candidates.

It is further noted that the user interface module 211 may operate in connection with the communication module 209 to facilitate the exchange of real-time location information and/or transport mode information via the communication network 107 with respect to the services 109, content providers 115 and applications 111. Alternatively, the communication module 209 may facilitate transmission of the real-time location information and/or the transport mode information directly to the services 109 or content providers 115.

The above presented modules and components of the routing platform 105 can be implemented in hardware, firmware, software, or a combination thereof. Though depicted as a separate entity in FIG. 1A, it is contemplated that the platform 105 may be implemented for direct operation by respective UEs 101 and/or vehicles 103. As such, the routing platform 105 may generate direct signal inputs by way of the operating system of the UE 101 and/or vehicles 103 for interacting with the application 111. In another embodiment, one or more of the modules 201-211 may be implemented for operation by respective UEs 101 and/or vehicles 103 as a platform 105, cloud based service, or combination thereof.

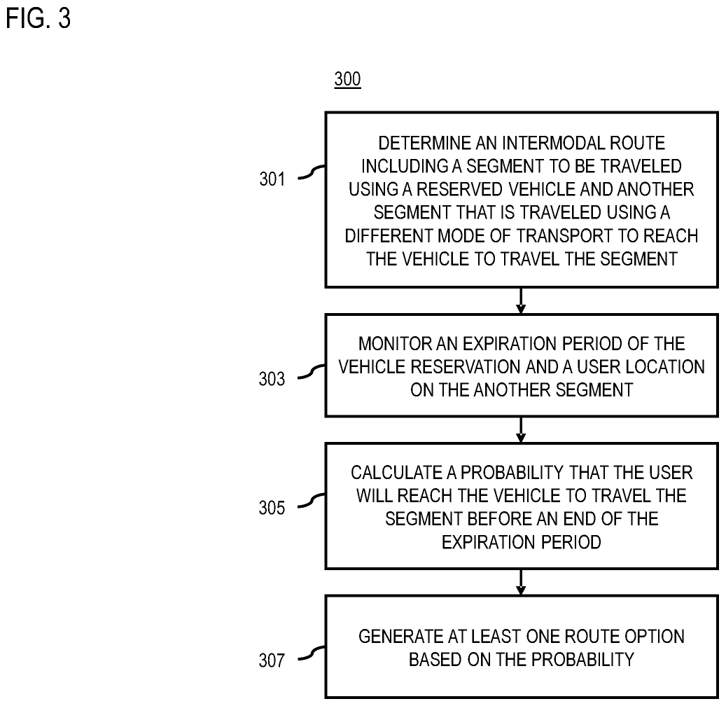

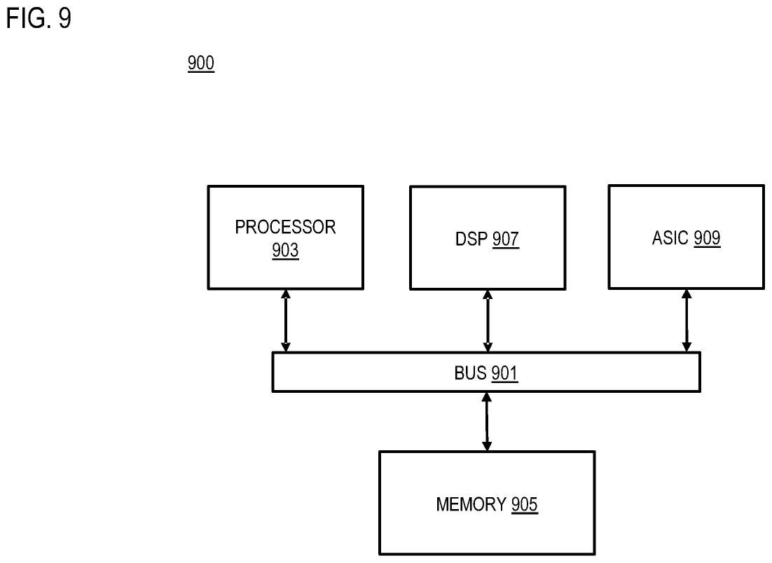

FIG. 3 is a flowchart of a process for managing a vehicle reservation used in an intermodal route, according to one embodiment. In one embodiment, the routing platform 105 performs the process 300 and is implemented in, for instance, a chip set including a processor and a memory as shown in FIG. 9. In addition or alternatively, all or a portion of the process 300 may be performed locally at the UE 101 and/or vehicle 103 (e.g., via the application 111 or another equivalent hardware and/or software component).

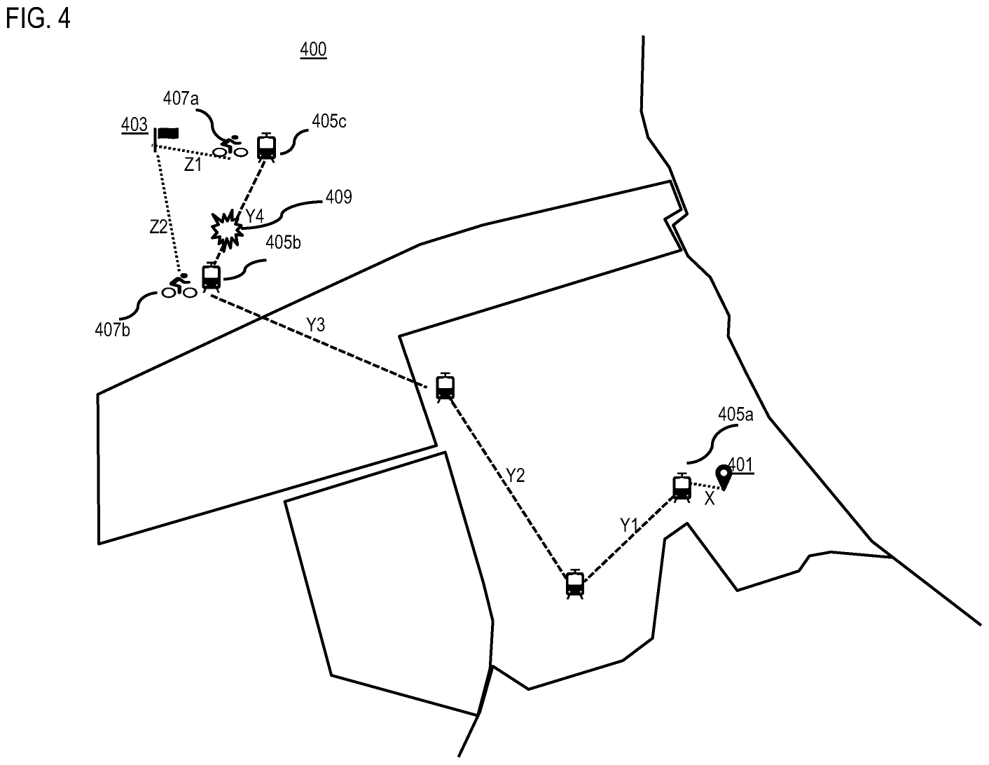

In step 301, the routing platform 105 determines an intermodal route using intermodal and multimodal routing algorithms. The intermodal route includes a segment to be traveled using a reserved vehicle and another segment that is traveled using a different mode of transport to reach the vehicle to travel the segment. FIG. 4 is a diagram of a candidate route and respective travel segments, according to one embodiment. For example, a user at a current location 401 at 17:00 needs to reach a destination 403 by 18:00. To simplify the discussion, FIG. 4 shows travel segments as straight lines instead of real-world road lines on a map. The routing platform 105 determines the candidate route as the optimal route among all available transport modes available to the user during the time frame in the area. In this case, the optimal route includes a walking segment (X) to a subway stop 405a, a subway segment (Y1+Y2+Y3+Y4) from the subway stop 405a to a subway stop 405b, and a shared bicycle segment (Z1) from a bicycle pickup location 407a to the destination 403. Based on the subway schedule, the routing platform 105 reserves a bicycle for 17:30 to 18:00, instead of walking for the last segment to meet the time threshold of 18:00.

The routing platform 105 deploys various vehicle reservation strategies depending on the cost function, user preferences (e.g., comfort, vehicle models, vehicle seat numbers, cruise control, etc.), and/or user context, etc.

For example, the routing platform 105 applies vehicle reservation strategies depending on when the “reservation timer” will expire. In one embodiment, the booking expiration happens during the trip due to a delay in the public transport or traffic jams. In another embodiment, a booking expiration is already known upfront at the original route computation time, e.g., when the bicycle can only be booked for 30 minutes while walking plus taking subway takes 45 minutes. Based on the situation, the routing platform 105 proposes the user the best/optimal way to manage and keep the route “alive”.

In one embodiment, the routing platform 105 monitors vehicle availability and trends at one or more locations of interest. When the routing platform 105 determines that a booking will expire in 15 min and the user cannot be at the vehicle pickup location on-time and that the number of options at that vehicle pickup location are decreasing (e.g., 10 available bikes at the first subway station at an original booking time 17:00, then only 4 bikes available 15 minutes before the booking expiration). The routing platform 105 then decides to make a proactive cancelling of the current booking to secure another bicycle, knowing that this new booking should allow sufficient time for the user to reach that vehicle pickup location.

In another embodiment, the routing platform 105 makes a booking with a different provider, e.g., shared bicycle operator in case several options are available at the vehicle pickup location.

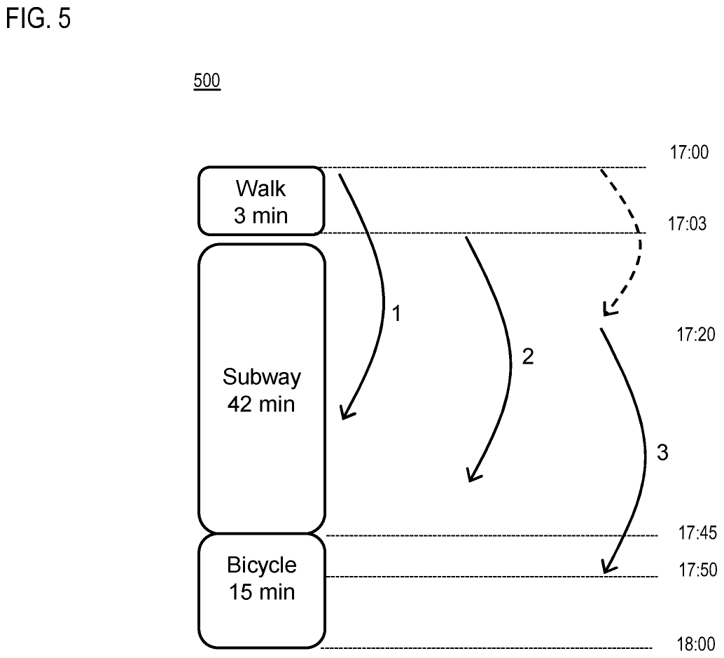

FIG. 5 is a diagram of vehicle reservation strategies, according to various embodiments. For example, the routing platform 105 computes the time of 45 minutes to reach the bicycle (including walk 3 minutes to the subway stop and 42 minutes of subway ride). In one embodiment, the routing platform 105 considers a “1” scenario of booking the bicycle at 17:00 with a maximum bicycle reservation time (e.g., 30 minutes). However, the reservation duration only lasts to 17:30 which is not sufficient to keep the booking for the user to arrive at 17:45.

In another embodiment, the routing platform 105 considers a “2” scenario of booking the bicycle at 17:03 when boarding the subway with the maximum bicycle reservation time. However, the reservation duration only lasts to 17:33 which is still not sufficient to keep the booking for the user to arrive at 17:45.

In yet another embodiment, the routing platform 105 considers a “3” scenario of sets a trigger to book the bicycle at 17:20 (i.e., 25 minutes before the estimated arrival time 17:45), so there is a 5 minutes buffer. Optionally, the routing platform 105 makes a short initial booking and cancels it at 17:20 prior to making the 17:20-17:50 reservation.

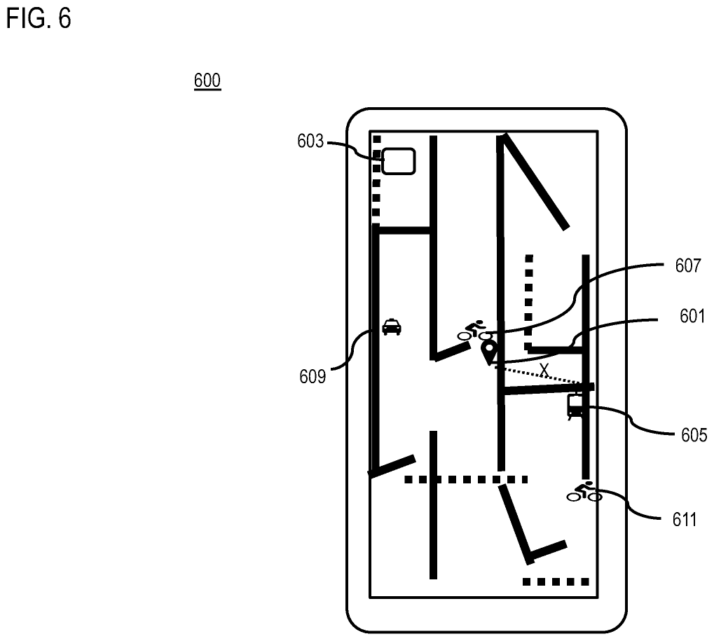

FIG. 6 is a diagram of a user interface used in the processes for managing a vehicle reservation used in an intermodal route, according to one embodiment. As shown in FIG. 6, a user interface (UI) 600 presents candidate routes near a user location 601 for traveling to a user destination When the user selects a routing icon 603, transport icons 605, 607, 609, 611 of various transport modes are depicted on UI 600. In one embodiment, the user can trigger the display of detailed information of a transport icon by selecting one transport icon. Referring back to the optimal route to travel to the user destination 403 in FIG. 4, the routing platform 105 and/or the user activates the subway icon 605 and navigates the user to walk to the subway stop 405a along the first segment (X) to catch the subway of the second segment (Y1+).

In step 303, the routing platform 105 monitors an expiration period of the vehicle reservation and a user location on the another segment. The routing platform 105 continues monitors real-time user/subway train location. In step 305, the routing platform 105 calculates a probability that the user will reach the vehicle to travel the segment before an end of the expiration period. In one embodiment, the routing platform 105 periodically or continuously calculates the probability based on real-time user/subway train location data.

In another embodiment, the routing platform 105 calculates the probability in response to one or more triggers, such as predicted and/or real-time event (e.g., protests), accident (e.g., terrorist attacks), and/or traffic data. For example, the routing platform 105 receives an alert of a mechanic failure 409 occurring at subway leg Y4 at 17:25. The routing platform 105 retrieves at least historic data of that subway line to calculate a probability that such mechanic failure on the train track can be fixed prior to the end of the bicycle reservation 18:00.

In step 307, the routing platform 105 generates at least one route option based on the probability. The at least one route option includes an extension the bicycle reservation, a creation of another bicycle reservation for the same bicycle or another bicycle of the same operator or a different operator at or near the pickup location, a creation of another vehicle reservation for a different vehicle type (e.g., shared scooter) with a similar estimated arrival time at or near the pickup location, a creation of another vehicle reservation for another vehicle at a different pickup location, etc.

In one embodiment, the routing platform 105 calculates a cost of the extension of the vehicle reservation based on the user location and provides data on the cost to the user before initiating the extension of the vehicle reservation. In another embodiment, the routing platform 105 automatically initiates the extension of the vehicle reservation based on determining that there are no other available route options.

In one embodiment, the routing platform 105 monitors an availability of candidate vehicles from which the another vehicle can be selected, wherein the creation of the another vehicle reservation as the at least one route options is based on the availability. In another embodiment, the routing platform 105 creates the another vehicle/bicycle reservation presented as the at least one route option based on determining that the another vehicle/bicycle is within a threshold distance of the user location, a location of the vehicle, the subway segment, and/or the bicycle segment.

In one embodiment, the routing platform 105 proactively cancels the vehicle reservation based on determining that the user can reach a vehicle location of the another vehicle before another expiration period associated with the another reservation.

In one embodiment, the routing platform 105 determines that there is another intermodal route with an estimated time of arrival, a travel distance, or a combination thereof that is within a threshold similarity of the intermodal route and presents the another intermodal route as the at least one route option.

In one embodiment, the routing platform 105 determines an availability of another vehicle provider to provide the another vehicle to travel the intermodal route and provides data on the another provider as the least one route option.

In one embodiment, the routing platform 105 automatically initiates the at least one route option based on determining that the user location is in an area with low or no device data connectivity.

For example, the routing platform 105 determines that such mechanic failure on the train track will not be fixed after 1-2 hours, thus generates route options of an extension the shared bicycle reservation at a pickup location 407a (next to the subway stop 405c), a creation of another shared bicycle reservation at another pickup location 407b (next to a subway stop 405b which is one stop early) further away from the destination 403 yet making in time to the destination 403, etc.

In one embodiment, the routing platform 105 automatically decides the route option for the user based on a cost function including routing cost function parameter such as distance, fuel efficiency, etc. customized for the user. In other embodiments, the routing platform 105 automatically decides the route option and an optimum shared vehicle for the user based on the cost function, user preferences (e.g., comfort, vehicle models, vehicle seat numbers, cruise control, etc.), and/or user context, etc. For example, such an optimum shared vehicle may be the best transport mode that satisfies the requesting user's criteria (such as available now, within 2-minute walking distance, and cost less than $5).

In other embodiments, the user may decide to have some settings on or off per default in order to keep some control over the application while dealing with some other situations in which the user would want to extend a booking but is not able to. For example, when the user is in a subway train, the user is not informed or able to make a new booking due to low/no internet connectivity, the routing platform 105 automatically extends the reservation or re-book a new reservation.

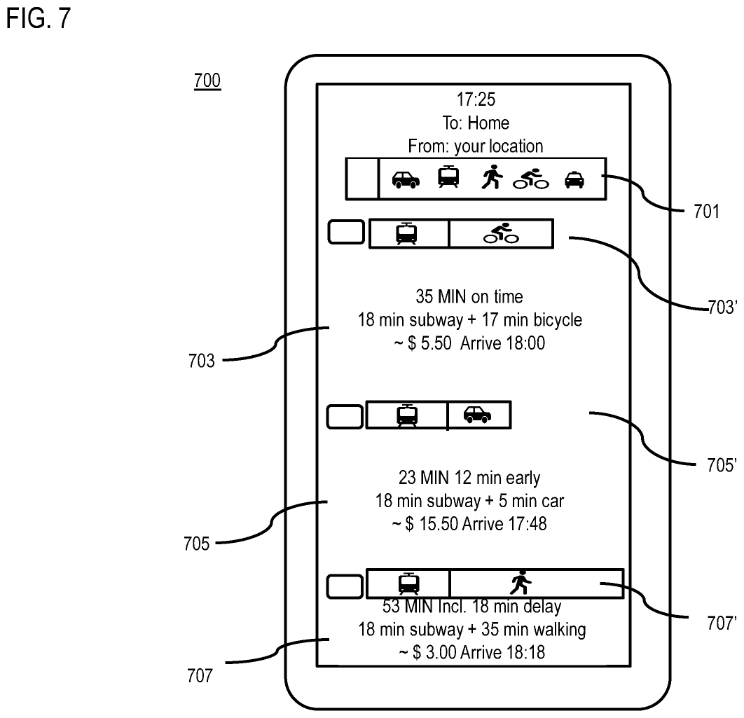

FIG. 7 is a diagram of a user interface used in the processes for managing a vehicle reservation used in an intermodal route, according to one embodiment. More specifically, FIG. 7 illustrates a user interface 700 that can be used in real-time by UEs 101 participating in a routing service provided by the system 100. For example, the routing platform 105 presents the route options and respective information in an order as in FIG. 7 based on the cost function, user preferences, and/or user context, etc. for the user to select one route option.

For example, as shown, the UI 700 shows a transport mode bar 701 (including car, subway, walking, cycling, and taxi) and sample detailed information 703, 705, 707 of three route options for the user determined based of the afore-discussed routing mechanisms.

Referring back to the example depicted in FIG. 4, the routing platform 105 receives an alert of a mechanic failure 409 occurring at subway leg Y4 at 17:25, calculates an on-time probability, and determines rout options to cope with the delay. The first route option information 723 depicts a travel time of 35 minutes that includes 18-minute subway time and 17-minute cycling time (with no delay). The first route option information 723 further depicts a cost $5.50 arriving at 18:00 at the destination (e.g., home).

The second route option information 725 depicts a travel time of 23 minutes of a user location segment that includes 18-minute subway time and 5-minute vehicle riding time (with a 12-minute early). The second route option information 725 further depicts a cost $15.50 arriving at 17:48 at the user's home. The second route option takes 12-minute shorter than the first route option, while costing $10.00 more.

The third route option information 727 depicts a travel time of 53 minutes that includes 18-minute subway time and 35-minute walking time (with an 18-minute delay). The third route option information 727 further depicts a cost $3.00 arriving at 18:18 at the user's home. The third route option requires the user to walk 35-minute to the home and the trip takes 18-minute longer than the first route option, while costing $2.50 less.

In addition to the route option information 723, 725, 727 of the shared vehicles, FIG. 7 illustrates a graphic travel time bar for each segment of a corresponding route option as 723′, 725′, 727′, while the portion of the bar represents a length of time of subway vs. other transport mode. For example, the graphic travel time bar 723′ has a first portion with a subway symbol representing riding subway 18-minute, and a second portion with a cycling symbol representing cycling 17-minute. As another example, the graphic travel time bar 725′ has a first portion with a subway symbol representing riding subway 18-minute, and a second portion with a shared car symbol representing car-riding 5-minute.

In order to make such intermodal combinations possible, the routing platform 105 collects booking policy data from various shared vehicle companies, such as duration, number of times, costs, etc. For example, a booking policy limits by duration or number of times (e.g., booking limited to 40 min or 2 bookings per day). Another booking policy limits the booking contextually, i.e., based on the availability of vehicles in a given area, such as not restrict bookings when there are more than three vehicles available at a pickup location, otherwise apply more restrictive booking policies. Another booking policy takes user's personal situations into account. When this is the only vehicle available for the user to travel the journey, the reservation time frame is more flexible. When a rebooking is due to some unavoidable delay, the reservation time frame is more flexible.

The computation of the different embodiments mentioned previously can be done partially or totally on servers/cloud, or at the edge of the network in order to balance the network load/cellular usage.

The above-discussed embodiments allow users to optimize travel efficiency by considering the most efficient and cost effective combination of all possible transport mode (including public transport, shared vehicles, etc.) to travel the last segment of the trip with a shared vehicle instead of walking.

The above-discussed embodiments increase usage of the vehicles by reserving them for the users at pickup locations. The above-discussed embodiments allow the vehicles being dynamically reserved with a low cost or no cost, considering the cost function, user preferences (e.g., comfort, vehicle models, vehicle seat numbers, cruise control, etc.), and/or user context, etc.

The above-discussed embodiments real-time monitor the travel status of the user and adjust the route options considering predictive and live traffic delays.

The above-discussed embodiments allow users to always use the most efficient intermodal route by monitoring, validating and managing vehicle reservation expirations along the journey.

The above-discussed embodiments enable new user experiences using smart intermodal routing with dynamic booking capabilities. The complexity of the bookings can be made simple for the user by being automated, extended when needed, all in the background and taking into account the constraints of the transports and providers.

The above-discussed embodiments combine different technologies (sensors, predictive parking, probability computation, multimodal routing, etc.) to provide a platform for mobility providers to share their data and get insights of candidate routes via combining many types of data sets, thereby determining candidate vehicle pickup locations and develop multi and intermodal transport solutions.

The processes described herein for managing a vehicle reservation used in an intermodal route may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

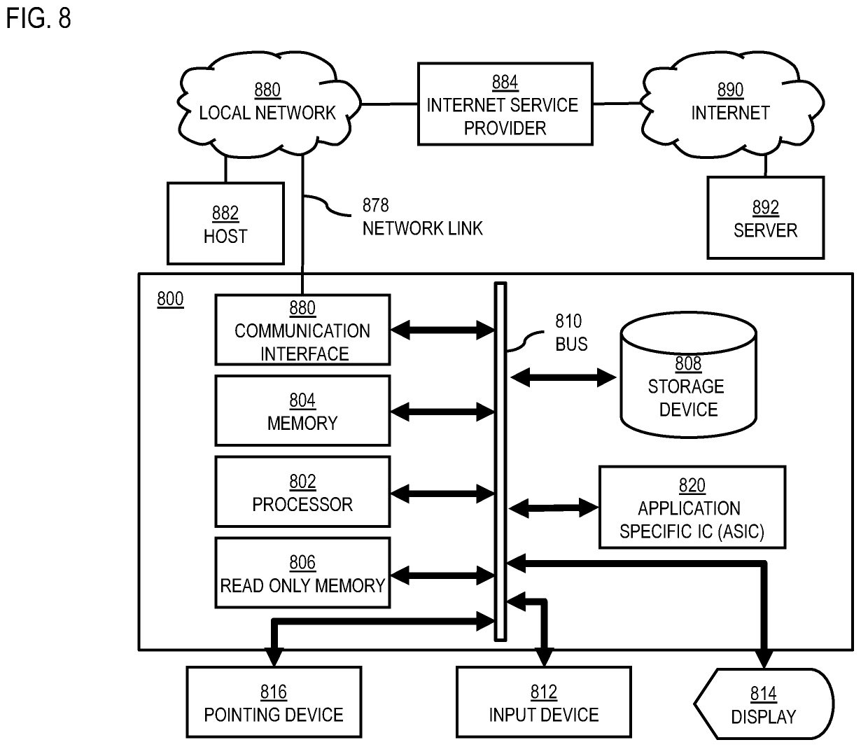

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide shared vehicle availability detection based on vehicle trajectory information as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of managing a vehicle reservation used in an intermodal route.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to manage a vehicle reservation used in an intermodal route. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for managing a vehicle reservation used in an intermodal route. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for managing a vehicle reservation used in an intermodal route, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 880 coupled to bus 810. Communication interface 880 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 880 may be a parallel port or a serial port or a universal serial bus (USB) port on a personal computer. In some embodiments, communications interface 880 is an integrated services digital network (ISDN) card or a digital subscriber line (DSL) card or a telephone modem that provides an information communication connection to a corresponding type of telephone line. In some embodiments, a communication interface 880 is a cable modem that converts signals on bus 810 into signals for a communication connection over a coaxial cable or into optical signals for a communication connection over a fiber optic cable. As another example, communications interface 880 may be a local area network (LAN) card to provide a data communication connection to a compatible LAN, such as Ethernet. Wireless links may also be implemented. For wireless links, the communications interface 880 sends or receives or both sends and receives electrical, acoustic or electromagnetic signals, including infrared and optical signals, that carry information streams, such as digital data. For example, in wireless devices, such as mobile computers like vehicle infotainment system, the communications interface 880 includes a radio band electromagnetic transmitter and receiver called a radio transceiver. In certain embodiments, the communications interface 880 enables connection to the communication network 107 for managing a vehicle reservation used in an intermodal route to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 880, carry information to and from computer system 800. Computer system 800 can send and receive information, including program code, through the networks 880, 890 among others, through network link 878 and communications interface 880. In an example using the Internet 890, a server host 892 transmits program code for a particular application, requested by a message sent from computer 800, through Internet 890, ISP equipment 884, local network 880 and communications interface 880. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 880 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

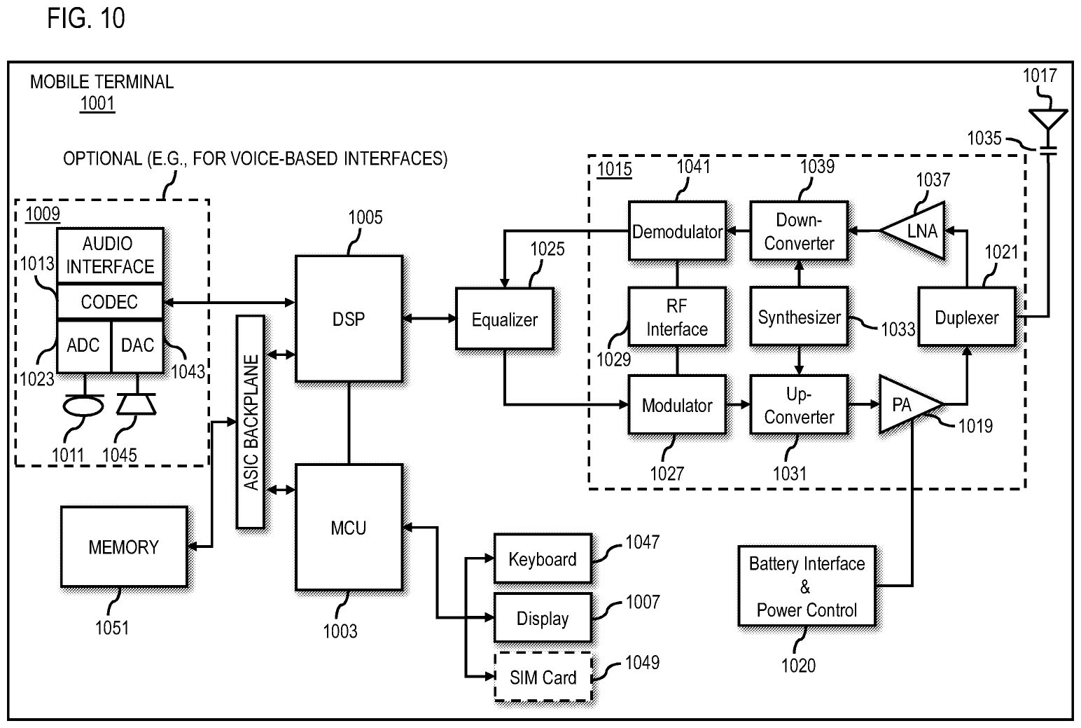

FIG. 9 illustrates a chip set or chip 900 upon which an embodiment of the invention may be implemented. Chip set 900 is programmed to provide shared vehicle availability detection based on vehicle trajectory information as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of managing a vehicle reservation used in an intermodal route.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide shared vehicle availability detection based on vehicle trajectory information. The memory 905 also stores the data associated with or generated by the execution of the inventive steps.

FIG. 10 is a diagram of exemplary components of a mobile terminal (e.g., mobile computers such as vehicle infotainment system, vehicle embedded system, smartphones, etc.) for communications, which is capable of operating in the system of FIG. 1, according to one embodiment. In some embodiments, mobile terminal 1001, or a portion thereof, constitutes a means for performing one or more steps of managing a vehicle reservation used in an intermodal route. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile computer or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile computer or a similar integrated circuit in network device (e.g., a cellular network device or data other network devices).

Pertinent internal components of the mobile terminal include a Main Control Unit (MCU) 1003, a Digital Signal Processor (DSP) 1005, and a receiver/transmitter unit. In one embodiment, wherein voice-based interaction and/or communications are supported at the mobile terminal, the mobile terminal may also include a microphone gain control unit and a speaker gain control unit. A main display unit 1007 provides a display to the user in support of various applications and mobile terminal functions that perform or support the steps of managing a vehicle reservation used in an intermodal route. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. In embodiments supporting voice-based interactions and/or communications, an audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station (e.g., data and/or voice communications), which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, data to support managing a vehicle reservation used in an intermodal route is formatted into network packets (e.g., Internet Protocol (IP) packets) for transmission using one or more network transmission protocol (e.g., a cellular network transmission protocol described in more detail below). In one embodiment, the network packets include control information and payload data, with the control information specifying originating/destination network addresses, error control signals, signals for reconstructing the user data from the packets, and/or other related information. In embodiments supporting voice-based interaction and/or communications, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech recognition, speech encoding, channel encoding, encrypting, and interleaving.

In one embodiment, the processed network packets and/or voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission through the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The local base station or similar component then forwards data or network packets to a gateway server (e.g., a gateway to the Internet) for connectivity to network components used for providing shared vehicle availability detection. In embodiments supporting voice-based interactions and/or communications, voice signals may be forwarded from the local base station to a remote terminal which may be another mobile computer, cellular telephone, and/or any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide shared vehicle availability detection based on vehicle trajectory information. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details (e.g., data and/or voice subscriptions), and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for managing a vehicle reservation used in an intermodal route comprising:
determining that the intermodal route includes a segment to be traveled using a vehicle booked via the vehicle reservation, and another segment that is traveled using a different mode of transport for a user to reach the vehicle to travel the segment;
monitoring an expiration period of the vehicle reservation and a user location of the user on the another segment;
calculating a probability that the user will reach the vehicle to travel the segment before an end of the expiration period based on the user location; and
generating at least one route option based on the probability,
wherein the at least one route option includes an extension the vehicle reservation, a creation of another vehicle reservation for another vehicle, or a combination thereof.

2. The method of claim 1, further comprising:
calculating a cost of the extension of the vehicle reservation based on the user location; and
providing data on the cost to the user before initiating the extension of the vehicle reservation.

3. The method of claim 2, further comprising:
automatically initiating the extension of the vehicle reservation based on determining that there are no other available route options.

4. The method of claim 1, wherein the creation of the another vehicle reservation is presented as the at least one route option based on determining that the another vehicle is within a threshold distance of the user location, a location of the vehicle, the segment, the another segment, or a combination thereof.

5. The method of claim 1, further comprising:
monitoring an availability of candidate vehicles from which the another vehicle can be selected,
wherein the creation of the another vehicle reservation as the at least one route options is based on the availability.

6. The method of claim 1, further comprising:
proactively canceling the vehicle reservation based on determining that the user can reach a vehicle location of the another vehicle before another expiration period associated with the another reservation.

7. The method of claim 1, further comprising:
determining that there is another intermodal route with an estimated time of arrival, a travel distance, or a combination thereof that is within a threshold similarity of the intermodal route; and
presenting the another intermodal route as the at least one route option.

8. The method of claim 1, further comprising:
determining an availability of another vehicle provider to provide the another vehicle to travel the intermodal route; and
providing data on the another provider as the least one route option.

9. The method of claim 1, further comprising:
automatically initiating the at least one route option based on determining that the user location is in an area with low or no device data connectivity.

10. The method of claim 1, wherein the vehicle is a shared car, a shared bicycle, a shared scooter, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine that the intermodal route includes a segment to be traveled using a vehicle booked via the vehicle reservation, and another segment that is traveled using a different mode of transport for a user to reach the vehicle to travel the segment;
monitor an expiration period of the vehicle reservation and a user location of the user on the another segment;
calculate a probability that the user will reach the vehicle to travel the segment before an end of the expiration period based on the user location; and
generate at least one route option based on the probability,
wherein the at least one route option includes an extension the vehicle reservation, a creation of another vehicle reservation for another vehicle, or a combination thereof.

12. An apparatus of claim 11, wherein the apparatus is further caused to:
calculate a cost of the extension of the vehicle reservation based on the user location; and
provide data on the cost to the user before initiating the extension of the vehicle reservation.

13. An apparatus of claim 12, wherein the apparatus is further caused to:
automatically initiate the extension of the vehicle reservation based on determining that there are no other available route options.

14. An apparatus of claim 11, wherein the creation of the another vehicle reservation is presented as the at least one route option based on determining that the another vehicle is within a threshold distance of the user location, a location of the vehicle, the segment, the another segment, or a combination thereof.

15. An apparatus of claim 11, wherein the apparatus is further caused to:
monitor an availability of candidate vehicles from which the another vehicle can be selected,
wherein the creation of the another vehicle reservation as the at least one route options is based on the availability.

16. An apparatus of claim 11, wherein the apparatus is further caused to:
proactively cancel the vehicle reservation based on determining that the user can reach a vehicle location of the another vehicle before another expiration period associated with the another reservation.

17. An apparatus of claim 11, wherein the apparatus is further caused to:
determine that there is another intermodal route with an estimated time of arrival, a travel distance, or a combination thereof that is within a threshold similarity of the intermodal route; and
present the another intermodal route as the at least one route option.

18. A non-transitory computer-readable storage medium carrying one or more sequences of one or more instructions which, when executed by one or more processors, cause an apparatus to at least perform the following steps:
determining that the intermodal route includes a segment to be traveled using a vehicle booked via the vehicle reservation, and another segment that is traveled using a different mode of transport for a user to reach the vehicle to travel the segment;
monitoring an expiration period of the vehicle reservation and a user location of the user on the another segment;
calculating a probability that the user will reach the vehicle to travel the segment before an end of the expiration period based on the user location; and
generating at least one route option based on the probability,
wherein the at least one route option includes an extension the vehicle reservation, a creation of another vehicle reservation for another vehicle, or a combination thereof.

19. A non-transitory computer-readable storage medium of claim 18, wherein the apparatus is further caused to perform:
calculating a cost of the extension of the vehicle reservation based on the user location; and
providing data on the cost to the user before initiating the extension of the vehicle reservation.

20. A non-transitory computer-readable storage medium of claim 19, wherein the apparatus is further caused to perform:
automatically initiating the extension of the vehicle reservation based on determining that there are no other available route options.
